(19) United States
(12) Patent Application Publication
(10) Pub. No.: US 2026/0066695 A1
(43) Pub. Date: Mar. 5, 2026

(54) SYSTEMS AND METHODS FOR AUTOMATICALLY AND DYNAMICALLY REDISTRIBUTING ENERGY BETWEEN DATA SOURCES AND POWER SOURCES

(71) Applicant: BANK OF AMERICA CORPORATION, CHARLOTTE, NC (US)

(72) Inventors: Adam Kristian King, Fort Mill, SC (US); Stacy Ellis Ingle, Denver, NC (US)

(73) Assignee: BANK OF AMERICA CORPORATION, CHARLOTTE, NC (US)

(21) Appl. No.: 18/821,253

(22) Filed: Aug. 30, 2024

(51) Int. Cl. H02J 13/00; H02J 3/00

(52) U.S. Cl. CPC H02J 13/12; H02J 3/003; H02J 3/004

(57) ABSTRACT

Systems, computer program products, and methods are described herein for automatically and dynamically redistributing energy between data sources and power sources. The present disclosure is configured to identify a component associated with an energy consumption; receive, from at least one sensor associated with the component, real time energy consumption data of the component; determine, by a dynamic forecast module connected to the at least one sensor, a predicted energy consumption; generate an energy distribution network comprising at least one structurally flexible component and the component; apply at least one external factor to the at least one structurally flexible component based on the predicted energy consumption; and dynamically configure, based on the at least one external factor applied to the at least one structurally flexible component, at least one connection within the energy distribution network.

### TECHNOLOGICAL FIELD

Example embodiments of the present disclosure relate to systems and methods for automatically and dynamically redistributing energy between data sources and power sources.

### BACKGROUND

In electronic networks where many technical components such as servers, data centers, databases, user devices, and/or the like, are constantly connected and interact with each other, it is increasingly difficult to predict operational interruptions to each device and how energy should be redistributed to either prevent the operational interruption or reduce the bad affect of the operational interruptions to the devices. Thus, there exists a great need for a system that can automatically, efficiently, and dynamically redistribute energy between data sources and power source, both proactively (e.g., before interruptions occur) and reactively (e.g., in real time as interruptions occur).

Applicant has identified a number of deficiencies and problems associated with distributing energy between power sources and data sources in real time and in order to avoid inoperable power sources, technical components, and data sources. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for automatically and dynamically redistributing energy between data sources and power sources.

In one aspect, a system for automatically and dynamically redistributing energy between data sources and power sources is provided. In some embodiments, the system may comprise: a memory device with computer-readable program code stored thereon; at least one processing device operatively coupled to the at least one memory device and the at least one communication device, wherein executing the computer-readable code is configured to cause the at least one processing device to: identify a component associated with an energy consumption; receive, from at least one sensor associated with the component, real time energy consumption data of the component; determine, by a dynamic forecast module connected to the at least one sensor, a predicted energy consumption; generate an energy distribution network comprising at least one structurally flexible component and the component; apply at least one external factor to the at least one structurally flexible component based on the predicted energy consumption; and dynamically configure, based on the at least one external factor applied to the at least one structurally flexible component, at least one connection within the energy distribution network.

In some embodiments, the structurally flexible component comprises at least one of a Shape Memory Polymer (SMP) based component, a Liquid Metal Circuit (LMC) based component, a Shape-Memory Alloy (SMA), or an elastomeric polymer.

In some embodiments, the at least one sensor is embedded in at least one of an energy collection component, an energy distribution network, a liquid metal circuit (LMC) based component, an energy storage component, a feedback control loop component, an interface component, or a transfer component.

In some embodiments, the dynamic forecast module comprises at least one of a predictive model, a fuzzy logic model, or an optimization module.

In some embodiments, executing the computer-readable code is further configured to cause the at least one processing device to: collect historical data of the component; generate a first historical dataset of the component; train the first historical dataset to the dynamic forecast module at a first instance by applying the first historical dataset to the dynamic forecast module; collect real time data of the component at a current instance; train the real time data to the dynamic forecast module at a current instance by applying the real time data to the dynamic forecast module; and generate, by training the dynamic forecast module in the first instance and the current instance, the predicted energy consumption. In some embodiments, executing the computer-readable code is further configured to cause the at least one processing device to: generate, by the trained dynamic forecast module and based on the real time data, an energy consumption simulation of the component; determine, based on the energy consumption simulation, a future energy shortage or a future energy overload; and dynamically configure, at a future period and based on the determined future energy shortage or the future energy overload, at least one connection within the energy distribution network at the future period.

In some embodiments, executing the computer-readable code is further configured to cause the at least one processing device to: generate a fault control module, wherein the fault control module is operatively coupled with the component; compare, by the fault control module, the real time energy consumption data with at least one energy threshold for the component, wherein the at least one energy threshold is based on a collection of historical data of the component; and automatically shutdown the component in an instance where the real time energy consumption data meets or exceeds the at least one energy threshold for the component. In some embodiments, executing the computer-readable code is further configured to cause the at least one processing device to: dynamically configure, based on the automatic shutdown of the component, the at least one connection within the energy distribution network by applying the at least one external factor to the at least one structurally flexible component; automatically connect, within the energy distribution network and based on the dynamic configuration, the at least one structurally flexible component to at least one secondary component.

In some embodiments, executing the computer-readable code is further configured to cause the at least one processing device to: generate a feedback control loop operatively coupled to a plurality of sensors in a plurality of components associated with the energy distribution network; collect, by the plurality of sensors, real time data of the plurality of components, real time data of the energy distribution network, or real time data of a central processing unit (CPU) associated with the plurality of components; and dynamically configure, by the feedback control loop, the component, the plurality of components, the energy distribution network, or the CPU associated with the plurality of components.

In some embodiments, executing the computer-readable code is further configured to cause the at least one processing device to: generate, based on the real time energy consumption data and based on the predicted energy consumption, a forecast interface component for the component; transmit the forecast interface component to a user device associated with the energy distribution network; and trigger, based on the transmission of the forecast interface component, a configuration of a graphical user interface (GUI) of the user device with the forecast interface component.

Similarly, and as a person of skill in the art will understand, each of the features, functions, and advantages provided herein with respect to the system disclosed hereinabove may additionally be provided with respect to a computer-implemented method and computer program product. Such embodiments are provided for exemplary purposes below and are not intended to be limited.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for automatically and dynamically redistributing energy between data sources and power sources, in accordance with an embodiment of the disclosure;

FIG. 2 illustrates an exemplary machine learning (ML) subsystem architecture, in accordance with an embodiment of the disclosure;

FIG. 3 illustrates a process flow for automatically and dynamically redistributing energy between data sources and power sources, in accordance with an embodiment of the disclosure;

FIG. 4 illustrates a process flow for generating the predicted energy consumption, in accordance with an embodiment of the disclosure;

FIG. 5 illustrates a process flow for dynamically configuring a connection within the energy distribution network, in accordance with an embodiment of the disclosure;

FIG. 6 illustrates a process flow for automatically connecting the at least one structurally flexible component to at least one secondary component, in accordance with an embodiment of the disclosure;

FIG. 7 illustrates a process flow for dynamically configuring the component, the plurality of components, the energy distribution network, and/or the central processing unit associated with the plurality of components, in accordance with an embodiment of the disclosure;

FIG. 8 illustrates a flow diagram for triggering a configuration of a graphical user interface (GUI) of a user device with a forecast interface component, in accordance with an embodiment of the disclosure; and

FIG. 9 illustrates a flow diagram for automatically and dynamically redistributing energy between data sources and power sources, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

In electronic networks where many technical components such as servers, data centers, databases, user devices, and/or the like, are constantly connected and interact with each other, it is increasingly difficult to predict operational interruptions to each device and how energy should be redistributed to either prevent the operational interruption or reduce the bad affect of the operational interruptions to the devices. Thus, there exists a great need for a system that can automatically, efficiently, and dynamically redistribute energy between data sources and power source, both proactively (e.g., before interruptions occur) and reactively (e.g., in real time as interruptions occur).

Accordingly, the present disclosure provides for the identification of a component associated with an energy consumption; the receipt, from at least one sensor associated with the component, of real time energy consumption data of the component; the determination, by a dynamic forecast module connected to the at least one sensor of a predicted energy consumption; and the generation of an energy distribution network comprising at least one structurally flexible component and the component. Further, the present disclosure further provides for the application of at least one external factor to the at least one structurally flexible component based on the predicted energy consumption; and the dynamic configuration, based on the at least one external factor applied to the at least one structurally flexible component of at least one connection within the energy distribution network.

Thus, and in other words, the disclosure provides a system comprising structurally flexible components (e.g., shape-memory alloys (SMAs) or liquid metal circuits LMCs) that dynamically redistribute excess energy. The structurally flexible components may comprise flexible architecture that can physically reshape itself in response to fluctuations in energy supply and demand (e.g., based on heat variations or mechanical forces acting on the SMAs or liquid metal circuits) and efficiently reroute surplus energy to designated storage units, alternate power sources, and/or between data centers. By leveraging advanced materials and adaptive mechanisms, the invention ensures efficient energy utilization while minimizing waste. The disclosure combines these materials, embedded sensors, control algorithms to control these materials and automatically/dynamically determine or predict energy surpluses, and dynamically redistribute energy between power sources and/or data sources (e.g., data centers).

What is more, the present disclosure provides a technical solution to a technical problem. As described herein, the technical problem includes distributing energy between power sources and data sources in real time and in order to avoid inoperable power sources, technical components, and data sources. The technical solution presented herein allows for the automatic, accurate, dynamic and efficient redistribution of energy between sources and technical components associated with a network of components. In particular, the disclosure provided herein is an improvement over existing solutions to the distribution and redistribution of energy between technical components, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

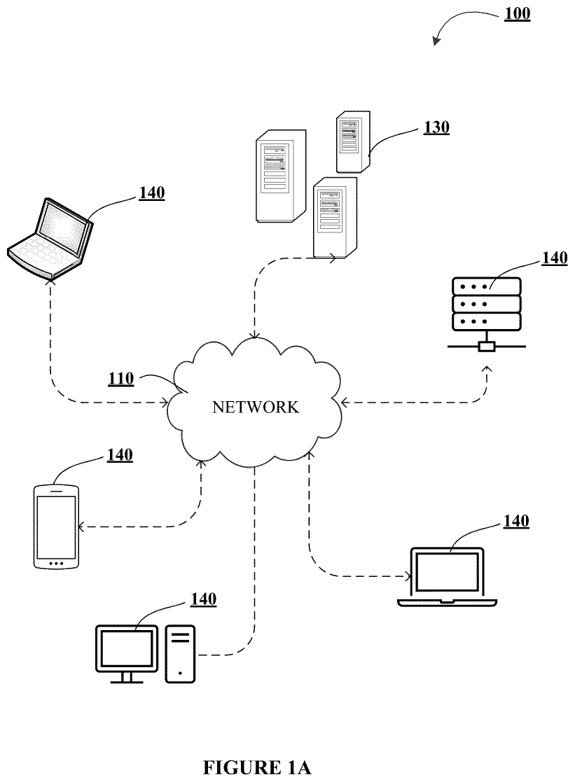

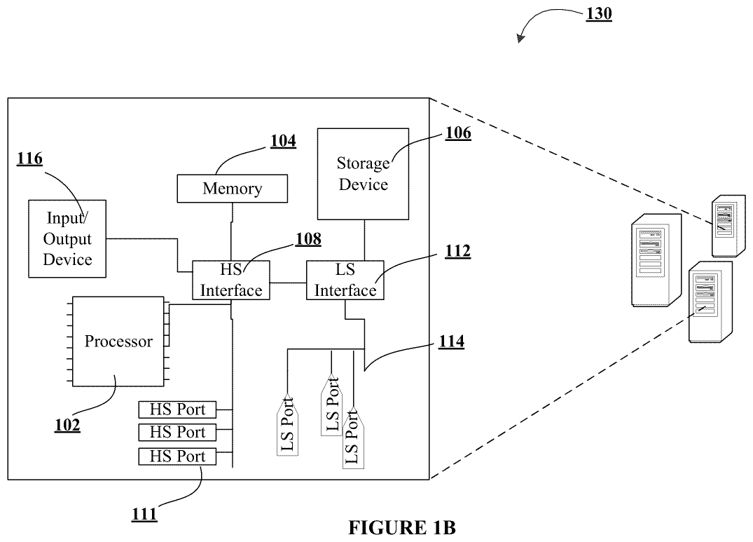

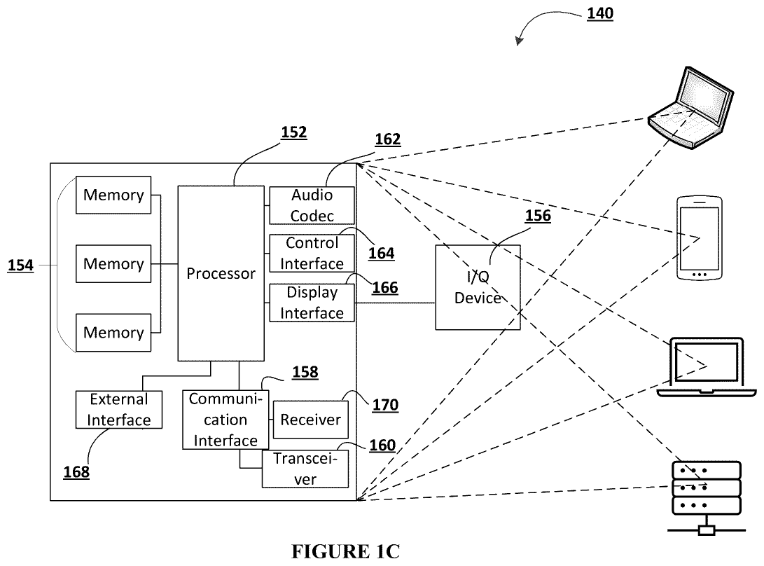

FIGS. 1A-1C illustrate technical components of an exemplary distributed computing environment for automatically and dynamically redistributing energy between data sources and power sources 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

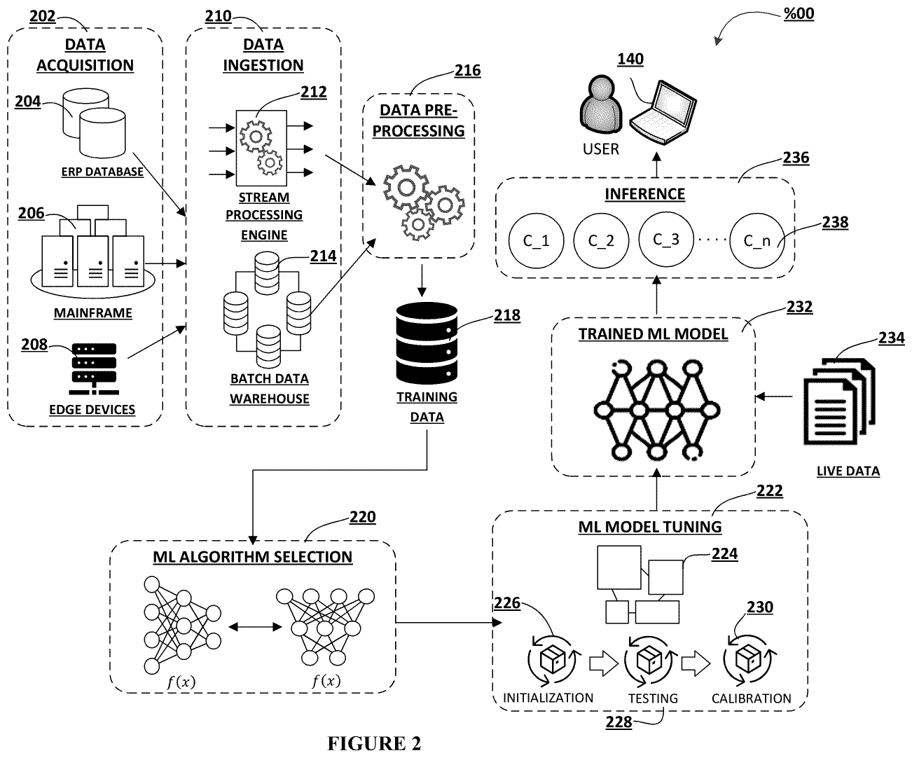

FIG. 2 illustrates an exemplary machine learning (ML) subsystem architecture 200, in accordance with an embodiment of the disclosure. The machine learning subsystem 200 may include a data acquisition engine 202, data ingestion engine 210, data pre-processing engine 216, ML model tuning engine 222, and inference engine 236.

The data acquisition engine 202 may identify various internal and/or external data sources to generate, test, and/or integrate new features for training the machine learning model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 222 may be used to train a machine learning model 224 using the training data 218 to make predictions or decisions without explicitly being programmed to do so. The machine learning model 224 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the machine learning model, the ML model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the ML model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical business decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

It will be understood that the embodiment of the machine learning subsystem 200 illustrated in FIG. 2 is exemplary and that other embodiments may vary. As another example, in some embodiments, the machine learning subsystem 200 may include more, fewer, or different components.

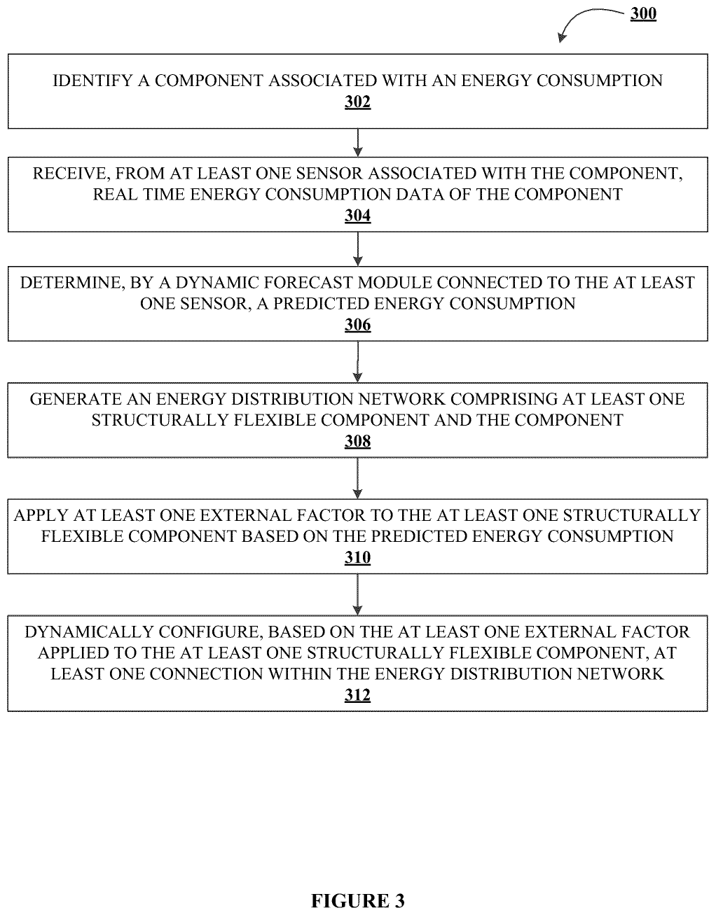

FIG. 3 illustrates a process flow 300 for automatically and dynamically redistributing energy between data sources and power sources, in accordance with an embodiment of the disclosure. In some embodiments, a system (e.g., similar to one or more of the systems described herein with respect to FIGS. 1A-1C) may perform one or more of the steps of process flow 300. For example, a system (e.g., the system 130 described herein with respect to FIG. 1A-1C) may perform the steps of process 300. In some embodiments, a machine learning model (e.g., such as the ML engine shown in FIG. 2) may perform some or all of the steps described in process flow 300.

As shown in block 302, the process flow 300 may include the step of identifying a component associated with an energy consumption. For instance, and in some such embodiments, the component may comprise a technical (or physical) component, such as a hardware component or computing equipment, a server, a networking component, a storage component, a cooling system component, a router component, a switch component, a controller, and/or the like. Thus, and in such embodiments, the system may identify at least one component (or a plurality of components) associated with a physical location, such as but not limited to a data center, an office building, and/or the like. In some embodiments, the system may identify the component (or a plurality of components) by crawling or spidering through the physical location's technical components and their associated connections. In some embodiments, the system may identify the component(s) associated with the physical location by accessing and parsing a database comprising the locations of each component, their associated current usage (e.g., based on current of the component, power consumption, heat, and/or the like), and/or the like. In some such embodiments, the database comprising the data of the component(s) may be supplemented with data regarding the current usage of each component by receiving current data from a sensor associated with the component (e.g., located close to, embedded within, and/or located proximately to the component). In some embodiments, the system itself may receive the data directly from the sensor(s) associated with the component(s), whereby the sensor(s) may collect current data of the component(s) and may transmit the data directly to the system for analysis.

Additionally, and in some embodiments, the energy consumption associated with each component may comprise, but is not limited to, a power consumption, a current consumption, a heat of the component, energy flow, and/or the like. In some embodiments, the energy consumption may be generated based on a sensor reading associated with the component, whereby the system may collect the current reading of the sensor (e.g., a heat reading, a current consumption reading, a power consumption reading, and/or the like), and the system may determine the energy consumption currently used by the component. In some such embodiments, the energy consumption may be measured in a Watt-hours or a similar unit of energy, and/or a total energy used over an amount of time (e.g., over 6 minutes, over an hour, over a 24 hour period, and/or the like). In some embodiments, the sensor may be placed near the component and may be configured to measure the heat of the component as the component is used. Additionally, and/or alternatively, a sensor may be coupled to and/or connected to the component using a wire, and the sensor may be configured to measure the electric energy or alternating current (AC) of the component by measuring the current which passes through the component.

As shown in block 304, the process flow 300 may include the step of receiving, from at least one sensor associated with the component, real time energy consumption data of the component. For example, the system may receive from a sensor associated with the component (or a sensor associated with a plurality of components and/or a plurality of sensors associated with a plurality of components) a real time or current energy consumption data of the component by the sensor collecting at least one of a current, a voltage, a heat, an energy flow, and/or the like.

In some embodiments, the sensor(s) may comprise lead-free piezoelectric ceramics, barium titranate (BaTiO₃; BT) based-, sodium potassium niobate ((K₁Na) NbO₃;KNN) based-, sodium bismuth titanate ((Bi_{1/2}Na_{1/2})TiO₃;BNT) based-ceramic systems, bismuth layer-structured ferroelectrics, and/or the like. For instance, and in some such embodiments, the sensors may comprise lead-free piezoelectric ceramics, which are ceramics that are used for converting mechanical stress into electrical signals, and are designed to be environmentally friendly by excluding lead. These materials—lead-free piezoelectric ceramics—are used in various sensors and actuators to detect and respond to physical changes. In some embodiments, the lead-free piezoelectric ceramics may generate electrical signals in response to applied mechanical stress, such as pressure or vibration, and may achieve this without environmental hazards associated with lead-free piezoelectric ceramics, making them suitable for applications where sustainability may be priority. By way of non-limiting example, the lead-free piezoelectric ceramics may comprise barium titranate ceramics, which offers excellent piezoelectric properties and is used in various applications, including but not limited to sensors, actuators, capacitors, and/or the like, without the environmental and health threats associated with lead-containing ceramics. Thus, and in some embodiments, the lead-free piezoelectric ceramics may be used sensors and control components within the system described herein. In some such embodiments, the lead-free piezoelectric ceramics may be incorporated into sensor modules and stress-detection systems within the system described herein, contributing to the overall monitoring and adaptation functions.

In some embodiments, the at least one sensor may be embedded in at least one of an energy collection component, an energy distribution network, a liquid metal circuit (LMC) based component, an energy storage component, a feedback control loop component, an interface component, a transfer component, and/or the like. For example, an energy collection component may comprises a shape-memory alloy which is embedded in the mechanical framework(s) of energy collectors that can adjust their shapes or orientations, which may enhance their ability to capture energy more effectively based on varying conditions. Additionally, an energy distribution network may comprise an embedded LMC shape-memory alloy (SMA), and/or a shape-memory polymer (SMP), an elastomeric polymer, whereby the shape-memory alloy may be used in flexible conduits and connectors within the energy distribution network, and the shape-memory alloy may dynamically alter its configurations to optimize the routing of energy and respond to changes in energy flow or system demands. Such an energy distribution network may comprise a liquid metal circuit which is embedded within the system's electrical distribution networks to provide flexible and adaptable electrical pathways which facilitates the efficient energy routing between energy sources and storage devices. In some embodiments, a liquid metal circuit (LMC) based component refers to a component that remains in a liquid state at room heat, and may comprise gallium-based alloys and/or eutectic-indium (EGaln) alloys. Additionally, an energy storage component may comprise a sensor(s) be embedded in storage units such as lithium-ion batteries, ultracapacitors, and/or phase-change materials (PCMs), providing data for effective energy management. In some embodiments, a feedback control loop component may comprise a sensor(s) that is embedded in a feedback control loop and/or components subject to variable energy loads, such as adjustable enclosures or self-regulating systems, to provide real-time performance data for maintaining optimal operation. Additionally, an interface component may comprise a sensor(s) that is placed in key junctions and/or interfaces between different system components to ensure accurate monitoring of energy transfer and system integration points. In some embodiments, a transfer component may allow for continuous and dynamic transferring of energy and/or power between components, by comprising a sensor embedded between the transfer components for accurate and real time reporting of transfers between the system components.

As shown in block 306, the process flow 300 may include the step of determining, by a dynamic forecast module connected to the at least one sensor, a predicted energy consumption. For instance, the system may use a dynamic forecast module which may be configured with at least one advanced control algorithm to make informed determinations about energy distribution between the system's components. Additionally, and/or alternatively, the dynamic forecast module may further comprise a machine learning model(s) that predict energy usage patterns in order to optimize energy distribution before potential problems arise. Thus, and in some embodiments, the dynamic forecast module may use the real time energy consumption data from the sensor(s) associated with the component(s), use at least one advanced control algorithm to process the real time energy consumption data and/or historical energy consumption data to make informed decisions about energy distribution, and may use a trained machine learning model (trained with historical energy consumption data and real time energy consumption data) to predict future energy distributions that will optimize the system's component(s).

In some embodiments, the advanced control algorithm may comprise a fuzzy logic algorithm, a predictive analysis model, an optimization algorithm, and/or the like. For example, and in some embodiments, the fuzzy logic algorithm may handle imprecise or uncertain data to adjust energy flows in a flexible manner, whereby the fuzzy logic algorithm may fill in or mimic real-world situations of energy flows historically and/or in the future. In some embodiments, the predictive analysis module may forecast future energy demand based on historical energy consumption data, which may allow the dynamic forecast module to proactively manage energy distribution. In some embodiments, the optimization algorithm may determine the most efficient way to allocate energy resources, balancing supply and demand dynamically. Additionally, and/or alternatively, the machine learning model used by the dynamic forecast module may analyze historical energy consumption data to forecast peak demand periods, which may allow the system (using the dynamic forecast module) to adjust energy flows accordingly and ensure any surplus energy is efficiently rerouted to storage units or alternate power sources.

Thus, and based on the real time energy consumption data, the dynamic forecast module may determine a predicted energy consumption for the component(s) based on the sensor data collected. In some embodiments, the predicted energy consumption may comprise an energy consumption at a future time (e.g., future to the current or real time) such as but not limited to, a time thirty seconds in the future, a time one minute in the future, a time within the next 24 hours in the future, a time in the next month or 28 days in the future, and/or the like.

Additionally, and in some embodiments, the dynamic forecast module may be continuously trained with a feedback loop, which may comprise its own sensor, for continuous feedback on the system's components and their real time energy consumption data, whether the real time energy consumption data was expected and followed the dynamic forecast module's predictions, and/or whether the energy distribution network should be reconfigured to meet the predicted needs of the system.

As shown in block 308, the process flow 300 may include the step of generating an energy distribution network comprising at least one structurally flexible component and the component. For instance, the system may generate an energy distribution network comprising at least one structurally flexible component and the component(s) associated with the energy consumption. In such embodiments, the structurally flexible component may comprise a structurally flexible connection connected at least at one time to the component, whereby the structurally flexible component may comprise a shape-memory alloy (SMA) based component, a liquid metal circuit (LMC) based component, a shape-memory polymer (SMP), an elastomeric polymer, and/or the like.

As used herein, the SMA may refer to a metallic material that “remember” their original shape and can revert back to the original shape upon experiencing a heating (to a particular heat), and/or a mechanical stress. For instance, and when an SMA is deformed (to a non-original shape), the SMA retains the new shape until the SMA is heated to a specific heat (and/or a range of heat values), at which point the SMA returns to its original shape/configuration. Thus, the SMA may facilitate the movement and reconfiguration of energy pathways within the system (e.g., by way of reconfiguring the energy distribution network and its connection(s)) by reconfiguring its connections between the new state and the original state. By way of non-limiting example, the SMA is a flexible component that dynamically changes its shape to reroute energy, and in an instance where a nickel-titanium SMA is used in a device and/or actuator, then the nickel-titanium wire actuator may adjust its configurating in response to heat changes, effectively managing energy flow within the system. In some embodiments, the SMA may comprise and/or be composed of alloys such as but not limited to nickel-titanium (NiTi), copper-aluminum-nickel, iron-platinum, and/or the like.

Further, and in some such embodiments, the SMA may be strategically integrated into key components associated with the system (e.g., associated with and/or controlled for energy distributions by the system described herein). For example, and in some such embodiments, the SMAs may be embedded in the mechanical frameworks of energy collectors to adjust the energy collectors' shapes and/or orientations, which may in turn enhance the energy collectors' ability to capture energy more efficiently based on varying conditions. Additionally, and in some embodiments, the SMA may be used in flexible conduits and/or connectors within the energy distribution network, whereby the SMA may dynamically alter its configuration to optimize the routing of energy and respond to changes in energy flow and/or system demands. In some embodiments, the SMAs may be incorporated into adaptive components, such as but not limited to adjustable energy panels and/or reconfigurable structural elements, whereby the SMAs may facilitate real-time adjustments and/or enhance overall system efficiency.

Additionally, and/or alternatively, the structurally flexible component may comprise an LMC. Such LMCs may use alloys that remain in a liquid state at room heat, but which solidify at non-room heat and may be manipulated (e.g., by force or mechanical pressure) to a new form. Thus, and in some such embodiments, the LMCs may be conductive and may be manipulated into different shapes, creating adaptable and flexible electrical pathways. Such LMCs may offer high flexibility as the LMCs can reconfigure themselves to match the change requirements, optimize energy routing and/or repair themselves in the event they're damaged. By way of non-limiting example, the LMC comprising a EGaln alloy may be integrated into the system described herein to create adaptable circuits, whereby the EGaln may be used to form flexible and reconfigurable connections that dynamically adjust to changes in energy flow or distribution, enhancing the system's ability to respond to varying energy demands. In some embodiments, the LMCs may comprise materials such as, but not limited to, gallium-based alloys, eutectic gallium-indium (EGaln) alloys, and/or the like.

Thus, and in some embodiments, the LMCs may be embedded within the system's electrical distribution networks to provide flexible and adaptable electrical pathways. The LMCs may facilitate energy routing between various energy sources and storage devices. In some embodiments, the LMCs may be used in critical connections that require flexibility and self-healing properties, ensuring that electrical pathways can dynamically adjust and repair themselves in response to changes or damage, which in turn maintains reliable energy and flow. In some embodiments, the LMCS may be included in components that need to adapt their configuration based on energy flow requirements, such as variable energy routing systems or adaptive interfaces between different system elements. In some embodiments, the LMCs may be implemented in interfaces or junctions where energy is transferred between different parts of the system and its components, allowing these connections to flexibly adjust and ensure continuous and reliable energy throughout the system.

Thus, and in some such embodiments, the system may generate, configure for a first time, and/or reconfigure the energy distribution network with at least one structurally flexible component which may be connected to the component discussed hereinabove, a different component associated with the system, and/or the like. Thus, and as the system analyzes the component(s) within its system (or associated with the system), the system may configure the energy distribution network between components such that energy, power, current, and/or the like, may flow dynamically as the needs change and arise (e.g., as a surplus of power is detected for component 1, the system may configure the energy distribution network to change the connection from the source and the component 1 to a connection between the source and a storage component such as a capacitor or other such battery component).

Thus, and in some such embodiments, the energy distribution network may comprise at least one component, a structurally flexible component, and/or the like. In some embodiments, the energy distribution network may comprise a plurality of components where at least one structurally flexible component may configure itself to generate connections between at least some of the plurality of components.

As used herein, a shape-memory polymer (SMP) refers to a material that can change its shape in response to external stimuli (external factor) such as but not limited to heat, light, and/or mechanical pressure/force, and/or the like. Further, such SMPs are engineered to undergo reversible changes in shape or stiffness. In some embodiments, the SMPs are designed to transition between different shapes or stiffness levels when exposed to specific stimuli. By way of non-limiting example, and upon heating, an SMP may return to its pre-programmed shape from a deformed shape. This ability to change shapes allows the system described herein comprising the SMP to physically adapt its structure in real time and automatically, which in turn, optimizes energy distribution by adjusting to varying energy demands. In some embodiments, the SMPs may be used in self-healing materials or deployable structures that can be incorporated into the system described herein to create flexible frameworks. By way of non-limiting example, the SMP may adjust its configuration in response to heat changes, enabling the SMP to efficiently manage energy flow by expanding or contracting to accommodate different energy levels. Such an SMP may adjust the geometry of energy pathways to better align with changing energy demands and levels.

Additionally, and in some embodiments, the SMPs may adjust structural elements that may direct energy. In some embodiments, the SMPs may be used in enclosures or housing that can change shape or stiffness in response to energy flow needs, which would allow for dynamic adjustment of the system's protective or containment features. In some embodiments, the SMPs may be incorporated into flexible energy conduits or pathways that can reconfigure themselves based on the energy distribution requirements, enabling efficient routing and redistribution of energy. In some embodiments, the SMPs may be applied in deployable or extendable structures within the system described herein that can adapt the SMP's shape or size to optimize energy management, such as but not limited to expanding or contracting energy-absorbing surfaces. In some embodiments, the SMPs may be used in structural frameworks that support or house other components of the system described herein, which may allow the framework to adjust its configuration to accommodate changes in energy flow and distribution needs.

As used herein, the elastomeric polymers refer to flexible materials that can stretch with permanent deformation. Such stretching may comprise a significant or great change to the shape of the elastomeric polymers. Thus, the elastomeric polymers are durable and elastic, making the elastomeric polymers suitable for applications requiring resilience. In some embodiments, the elastomeric polymers may return to their original shape after deformation, maintaining their elasticity and flexibility, which is essential for creating structural components in the system described herein that can adapt to dynamic energy conditions without permanent changes in their form. By way of non-limiting example, the elastomeric polymers may be used in flexible seals and gaskets that can be employed in the system described herein and its components to provide resilient and adaptable framework. For example, the elastomeric polymers might be used to create flexible joints or seals that can absorb and accommodate changes in the energy distribution, ensuring devices remain effective under varying conditions. In some embodiments, the elastomeric polymers may be employed in seals and/or joints within the energy storage components and/or energy distribution network to allow for movement and flexibility as the system adapts to changing conditions.

As shown in block 310, the process flow 300 may include the step of applying at least one external factor to the at least one structurally flexible component based on the predicted energy consumption. For instance, the system may apply at least one external factor, such as but not limited to heat (e.g., a particular heat or heat range), a physical pressure, a mechanically generated stress/pressure, and/or the like. Thus, and as used herein, the external factor refers to a force that is intended to and has the capability to configure the structurally flexible component to a new shape, its original shape, and/or the like. Thus, and by way of non-limiting example, if the structurally flexible component comprised SMA, and the SMA's original shape generated a connection between a source and a battery component, but the SMA had been configured using a first force or factor to connect the SMA to a secondary component that can use the power from the source, and in an instance where excess power is detected from a sensor, then the system may apply a particular heat (e.g., the heat required to convert the SMA to its original shape) to configure the SMA back to its original shape and send the excess power to the battery component for storage and later use.

In some embodiments, such a determination of when to apply the external factor to the structurally flexible component may be based on the expected energy consumption of the component. By way of non-limiting example, the system may determine the component has too great of an expected energy consumption for its normal operation (which may lead to a determination that the component is not operating normally and should be taken offline), and the system may apply the external force to the structurally flexible component in the energy distribution network to disconnect the component from the source and/or from other components connected to the in-operable component. By way of non-limiting example, the system may determine that the component is operating at too low of an expected energy consumption (e.g., the source of power may not be acting correctly and/or generating enough power, energy, current, and/or the like) and thus, the system may apply an external force to the structurally flexible component in the energy distribution network to disconnect the component from the source and connect the component to a battery component that has stored energy, power, current, and/or the like as a backup power source.

As shown in block 312, the process flow 300 may include the step of dynamically configuring, based on the at least one external factor applied to the at least one structurally flexible component, at least one connection within the energy distribution network. For instance, the system may dynamically configure, based on applying the external factor(s) to structurally flexible component(s), the at least one connection within the energy distribution network. In some embodiments, the system may dynamically configure the connection(s) within the distribution network by applying the at least one external factor to an isolated portion of the energy distribution network to only reconfigure the structurally flexible components within the isolated portion and thus, configure the connections within the isolated portion. In some such embodiments, the isolated portion may comprise only one structurally flexible component and/or a plurality of structurally flexible components. Additionally, and/or alternatively, the system may apply the external factor(s) to the whole energy distribution network, such that all the structurally flexible components in the energy distribution are affected (e.g., have the external factor applied to them). However, and in such embodiments, the type of external factor (e.g., the heat, the pressure, and/or the like) may only affect certain structurally flexible components within the energy distribution network, despite the entire energy distribution network (or a portion of the energy distribution network) having the external factor(s) applied to it. Thus, and based on the external factor chosen to for application to the energy distribution network and/or specific structurally flexible component(s) within the energy distribution network, only certain structurally flexible component(s) and/or all the structurally flexible components may be configured.

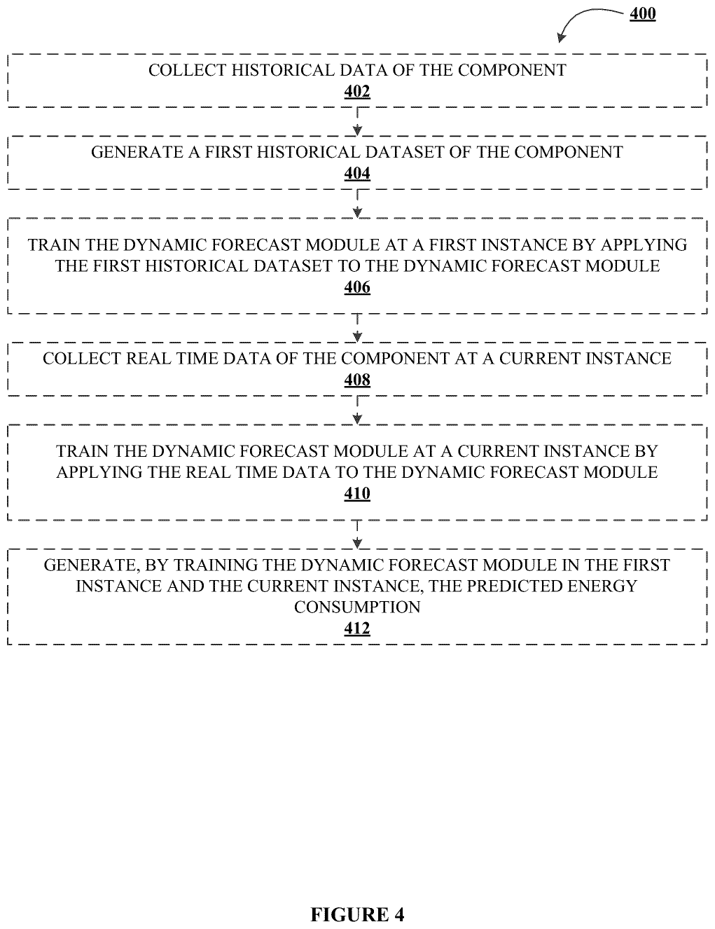

FIG. 4 illustrates a process flow 400 for generating the predicted energy consumption, in accordance with an embodiment of the disclosure. In some embodiments, a system (e.g., similar to one or more of the systems described herein with respect to FIGS. 1A-1C) may perform one or more of the steps of process flow 400. For example, a system (e.g., the system 130 described herein with respect to FIG. 1A-1C) may perform the steps of process 400. In some embodiments, a machine learning model (e.g., such as the ML engine shown in FIG. 2) may perform some or all of the steps described in process flow 400.

In some embodiments, and as shown in block 402, the process flow 400 may include the step of collecting historical data of the component. For example, and in some such embodiments, the system may collect historical data of the component described hereinabove, and/or historical data of all the components associated with the system, to generate a historical dataset of normal (and in some instances, abnormal) conditions of the component (or plurality of components) as the component(s) have operated in the past. Thus, and in such embodiments, the system may collect historical data of a component (or a plurality of components), and such historical data may comprise, but is not limited to, historical heat data, historical power consumption data, historical energy consumption data, historical current flow data, historical operational data (e.g., data showing the component was on, unexpectedly off, expectedly off, time to complete tasks, and/or the like), and/or the like. Thus, and in some such embodiments, the system may collect the historical data of the component(s) by using the sensors described hereinabove that are proximately located and/or connected to the component(s).

In some embodiments, and as shown in block 404, the process flow 400 may include the step of generating a first historical dataset of the component. For instance, and in some such embodiments, the system may generate at least a first historical data of the component based on the historical data collected for the component, which may be organized based on timestamps of the historical data as the historical data was generated, may be filtered to delete redundant data, and/or the like. In some embodiments, the historical data, before being used to generate the historical dataset, may be weighted based on importance to the overall component's purpose and its ability to carry out the purpose. In some embodiments, and in an instance where a plurality of components and their historical data is collected, then the system may isolate each component's historical data to generate a plurality of historical datasets separated by each component, such that each component may have its own at least one historical dataset.

Additionality, and in some embodiments, the system may continue to collect historical data to generate a plurality of historical datasets at later times than the first instance. Thus, and in such embodiments, the historical datasets applied to the dynamic forecast module may be applied at later and continuous instances after the first instance.

In some embodiments, and as shown in block 406, the process flow 400 may include the step of training the dynamic forecast module at a first instance by applying the first historical dataset to the dynamic forecast module. For example, and in some embodiments, the system may train the dynamic forecast module at least at a first instance by applying at least the first historical dataset to the dynamic forecast module. Thus, and in some such embodiments, the system may automatically train the dynamic forecast module by applying at least one historical dataset (or a plurality of historical dataset for one component or a plurality of components), such that the dynamic forecast module can determine past or historical instances of normal operation for the component(s) and, in some instances, can determine past or historical instances of abnormal operation for the component(s). In some embodiments, the historical datasets may comprise only normal operational data of the component(s), such that any abnormal operational data may be flagged as abnormal operations for the component(s). Additionally, and/or alternatively, the historical datasets may comprise both normal operational data and abnormal operational data of the component(s), such that the dynamic forecast module can be trained to with both types of operational data.

In some embodiments, and as shown in block 408, the process flow 400 may include the step of collecting real time data of the component at a current instance. For instance, and in some such embodiments, the system may collect real time data from the sensors associated with the system and associated with the component(s) of the system. In such embodiments, the sensor data may be collected in real time as the data is generated by the component(s) (e.g., heat data, power consumption data, current consumption data, energy flow data, and/or the like). Further, and in such embodiments, the sensor data may be collected a current instance (or a real time instance), which may occur at a later instance than the first instance (or other such instances associated with the historical data).

In some embodiments, and as shown in block 410, the process flow 400 may include the step of training the dynamic forecast module at a current instance by applying the real time data to the dynamic forecast module. For example, and in some embodiments, the system may train the dynamic forecast module by applying the real time data at a current instance, such that the dynamic forecast module may be trained by both historical data and current data for each component associated with the system. In this manner, the dynamic forecast module may comprise a whole picture or snapshot of the operational data for each component, which may then be used to generate predicted energy consumption of each component and whether the predicted energy consumption is normal and/or abnormal (e.g., and poses a problem for the functioning of the component and/or the connected components to the inoperable component).

In some embodiments, and as shown in block 412, the process flow 400 may include the step of generating, by training the dynamic forecast module in the first instance and the current instance, the predicted energy consumption. For instance, and in some such embodiments, the system may train the dynamic forecast module at least at a first instance and the current instance to generate the predicted energy consumption for the components that the dynamic forecast module has been trained on. Thus, and such embodiments, the predicted energy consumption may comprise at least one of an expectation or prediction of the heat of the component, a power consumption of the component, a current consumption, an energy flow, and/or the like. Thus, and in such embodiments, the predicted energy consumption may be determined as normal or abnormal based on past or historical operational data for the component. Additionally, and/or alternatively, the dynamic forecast module may determine a numerical value of the predicted energy consumption, such that the energy consumption of historical operational data may be compared to the predicted energy consumption, and used to determine the severity and/or intensity of the predicted operation of the component(s).

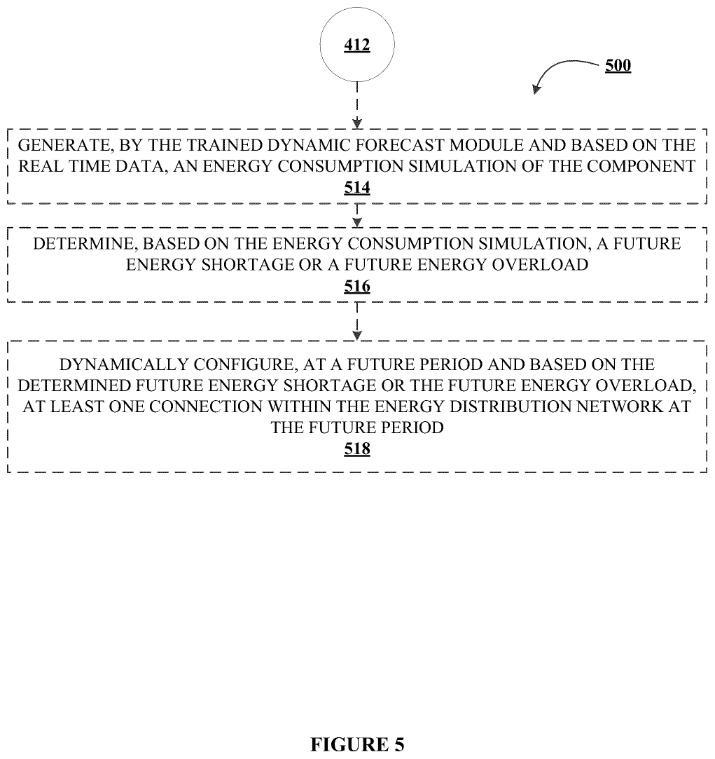

FIG. 5 illustrates a process flow 500 for dynamically configuring a connection within the energy distribution network, in accordance with an embodiment of the disclosure. In some embodiments, a system (e.g., similar to one or more of the systems described herein with respect to FIGS. 1A-1C) may perform one or more of the steps of process flow 500. For example, a system (e.g., the system 130 described herein with respect to FIG. 1A-1C) may perform the steps of process 500. In some embodiments, a machine learning model (e.g., such as the ML engine shown in FIG. 2) may perform some or all of the steps described in process flow 500.

In some embodiments, and as shown in block 514, the process flow 500 may include the step of generating, by the trained dynamic forecast module and based on the real time data, an energy consumption simulation of the component. For instance, and as shown herein, the process 500 and its blocks may occur after the process described hereinabove for FIG. 4. For instance, and in some embodiments, the system may generate an energy consumption simulation of the component, whereby the energy consumption simulation may show a historical and upcoming graph (e.g., a line graph) of the energy consumption levels of the component over different periods in time (e.g., historical periods of time, future periods of time, current period of time, and/or the like). Thus, and in some such embodiments, the system may generate a simulation that accurately and dynamically predicts the energy consumption of a component at various periods (including various future periods in time), and which may be used to dynamically configure the energy distribution network at the future periods in time when the system determines that it is necessary (e.g., when energy consumption is too low, too high, abnormal, and/or the like).

In some embodiments, and as shown in block 516, the process flow 500 may include the step of determining, based on the energy consumption simulation, a future energy shortage or a future energy overload. For instance, and in some such embodiments, the system may determine, based on the energy consumption simulation, a future energy shortage and/or future energy overload for the component associated with energy consumption simulation. Such a future energy shortage may be indicated by a low value of the predicted energy consumption shown in the energy consumption simulation at a future time(s). Additionally, and/or alternatively, the system may determine a future energy overload on the component associated with the energy consumption simulation, whereby the future energy overload may be indicated as a high value of the predicted energy consumption shown in the energy consumption simulation at a future time(s).

In some embodiments, the energy consumption simulation may comprise a plurality of lines graphs to show a plurality of predicted energy consumptions for a plurality of components, whereby the energy consumption simulation may show all the components (associated with the system) and their associated historical and future energy consumption levels separated so each line is associated with each component. Thus, and in such embodiments, the system may determine a future energy shortage and/or a future energy overload for each of the components based on the plurality of lines shown in the energy consumption simulation. In such embodiments, the future energy shortage and/or a future energy overload for each of the components may be determined at one time.

In some embodiments, and as shown in block 518, the process flow 500 may include the step of dynamically configuring, at a future period and based on the determined future energy shortage or the future energy overload, at least one connection within the energy distribution network at the future period. In some embodiments, the system may dynamically configure at least one connection with the energy distribution network by applying at least one external factor to the structurally flexible component in the energy distribution network at the future period associated with the determined future energy shortage and/or future energy overload.

Thus, and in this manner, the system can proactively determine potential future energy shortages and/or future energy overloads, reconfigure how energy should be transmitted within the energy distribution network, the proper recipient of the energy within the energy distribution network (e.g., to and/or from a particular component to and/or from a secondary component) to avoid overloading on a component, to avoid a shortage or inoperability of a component, and/or the like. Therefore, and importantly the dynamic forecast module may comprise machine learning techniques and scenario simulations to continually update the dynamic forecast module's predictions based on current and predicted/anticipated conditions. Thus, such a dynamic forecast module enables the system to adjust energy distribution strategies proactively to handle energy shortages and/or system overloads before they occur.

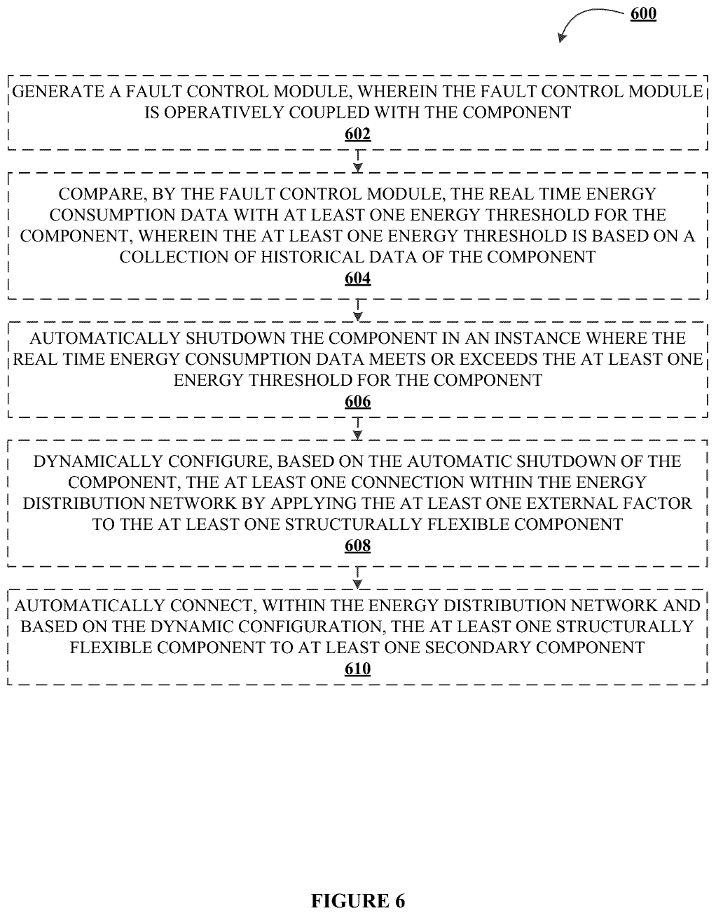

FIG. 6 illustrates a process flow 600 for automatically connecting the at least one structurally flexible component to at least one secondary component, in accordance with an embodiment of the disclosure. In some embodiments, a system (e.g., similar to one or more of the systems described herein with respect to FIGS. 1A-1C) may perform one or more of the steps of process flow 600. For example, a system (e.g., the system 130 described herein with respect to FIG. 1A-1C) may perform the steps of process 600. In some embodiments, a machine learning model (e.g., such as the ML engine shown in FIG. 2) may perform some or all of the steps described in process flow 600.

In some embodiments, and as shown in block 602, the process flow 600 may include the step of generating a fault control module, wherein the fault control module is operatively coupled with the component. For example, and in some such embodiments, the system may generate a fault control module which may be operatively coupled (or connected) to a component associated with the system. Such a fault control module may comprise a fault control algorithm which may be coupled to the system to trigger when a fault is detected (e.g., a fault on the energy consumption level of the component) and the fault is outside of the threshold limits for the component (e.g., which may be based on a threshold specific to the component, and/or a general threshold applied to all the components associated with the system), the fault control module may automatically shutdown the affected component(s) and in real time. In some such embodiments, the fault control module may take the real-time sensor readings (the real time data) of the component(s), determine whether the real time data is outside of a pre-defined threshold (which may be based on previous instances of major operational failures, and/or the like) and may automatically trigger a shut down or disconnection of the component within the energy distribution network. By way of non-limiting example, if the real time data showed a component having an unexpected increase or decrease in heat in its cooling system, then the system could automatically shut down the component and send an alert to a user device associated with the operation of the component to review and fix the component before it is brought back online. Thus, the fault control module may prevent overheating of the component, adjust the system's cooling parameters to maintain stability (by placing other components online and/or adjusting the other component's heat features, switch it to a backup while calling or maintenance, and/or the like).

Additionally, and in some embodiments, the fault control module may be placed or installed at key (or important) points in the system's network of components (e.g., critical energy nodes or high-value components) which may provide localized fault detection and response capabilities to the most important components within the network of components.

In some embodiments, and as shown in block 604, the process flow 600 may include the step of comparing, by the fault control module, the real time energy consumption data with the at least one energy threshold for the component, wherein the at least one energy threshold is based on a collection of historical data of the component. Thus, and in some embodiments, the system may compare—using the fault control module—the real time energy consumption data with at least one energy threshold for the component (e.g., which may be specific to the particular component, and/or general for all the components associated with the system) to determine whether the real time energy consumption data is outside of the energy threshold limit for the component(s). In some embodiments, the energy threshold is based on a collection of historical data of the component to determine whether the real time energy consumption data is outside of what has occurred historically for the component (i.e., outside of the energy threshold). In some embodiments, the energy threshold may be based on the historical of all the similar components associated with the system, such that the system may determine if the particular component is operating within the bounds of historical energy consumption values for all the same type of components in the system.

In some embodiments, the energy threshold may be based on both the historical data of the particular component and the historical data of the components associated with the system, which may allow for a double layer of thresholds to compare the energy consumption data for the component to. Thus, and in some such embodiments, the system may prevent false negatives and/or false positives by having two layers of energy thresholds to compare to the energy consumption data.

In some embodiments, and as shown in block 606, the process flow 600 may include the step of automatically shutting down the component in an instance where the real time energy consumption data meets or exceeds the at least one energy threshold for the component. For instance, and in some such embodiments, the system may automatically shut down and/or disconnect the component in an instance where the real time energy consumption data meets or exceeds the at least one energy threshold for the component, such that the component may be taken offline until the problem has been addressed and fixed in the component. In some embodiments, such an automatic shutdown of the component may occur based on a configuration of the energy distribution network having at least one external factor applied to the structurally flexible component, whereby the structurally flexible component may disconnect the component by reconfiguring itself to disconnect the power source (and other such connections to the component) from the rest of the system's network of components.

In some embodiments, and as shown in block 608, the process flow 600 may include the step of dynamically configuring, based on the automatic shutdown of the component, the at least one connection within the energy distribution network by applying the at least one external factor to the at least one structurally flexible component. For instance, the system may dynamically configure—based on the automatic shutdown of the component—the at least one connection within the energy distribution network, such that the structurally flexible component may connect to a secondary component that can carry out the same or similar function as the shut down component. In some embodiments, the secondary component may comprise a power storage component, such as but not limited to a capacitor, a battery, and/or the like.

In some embodiments, and as shown in block 610, the process flow 600 may include the step of automatically connecting, within the energy distribution network and based on the dynamic configuration, the at least one structurally flexible component to at least one secondary component. Thus, and in some such embodiments, the structurally flexible component may have at least one external factor applied to it by the system, and the structurally flexible component may be automatically configured to connect to at least one secondary component in lieu of the shut down component.

In some such embodiments, the secondary component may comprise a power storage component, such as but not limited to a lithium-ion battery(ies), ultracapacitor(s), a phase-change material(s) (PCMs), and/or the like. Thus, and in some such embodiments, the lithium-ion batteries may be a rechargeable battery that is based on lithium-ion chemistry, and which allows the lithium-ion batteries to store and release electrical energy efficiently. Further, such lithium-ion batteries may operate by storing excess electrical energy during periods of low demand (e.g., when an inoperable component is shutdown and/or disconnected, and/or where the component as an energy overload), but when energy demand increases, the lithium-ion batteries may release stored energy to meet the higher demand. By way of non-limiting example, the lithium-ion batteries may be used in electronics to store surplus energy collected from various sources (e.g., power sources, components with excess energy, and/or the like). In some such embodiments, the lithium-ion batteries described herein may be installed in dedicated storage units within the system described herein, integrated with energy distribution pathways in the energy distribution network to release stored energy as required, and/or the like.

Additionally, and in some such embodiments, an ultracapacitor(s) may be used in the system describe herein. For instance, such ultracapacitors are energy storage devices that use electrostatic principles to store and release energy quickly and can delivery high power outputs in short bursts. Further, the ultracapacitors may store energy by accumulating electricity on conductive plates separated by an electrolyte, and the ultracapacitors may rapidly discharge stored energy, which may make the ultracapacitors ideal for applications and/or components requiring quick bursts of power. By way of non-limiting example, the ultracapacitors may handle rapid energy storage and release, complementing the lithium-ion batteries by addressing short-term power needs. In some such embodiments, the ultracapacitors may be strategically placed near high-demand areas within the system described herein.

Such placement of ultracapacitors may comprise, but are not limited to, energy-intensive components, rapid response systems, energy distribution hubs, dynamic load points, and/or the like. For instance, and in some such embodiments, and for the energy-intensive components, the ultracapacitors may be positioned close to components with high power demands, such as large motors, high powered sensors, and/or the like, which may provide immediate energy bursts during peak usage (which may be predicted using the energy consumption simulation for the component(s)). Further, and in some embodiments, for the rapid response systems, the ultracapacitors may be located near systems that require quick energy delivery and discharge, such as emergency backup systems and/or real-time data processing units. Additionally, and for the energy distribution hubs, the ultracapacitors may be integrated into key junctions of the energy distribution network to stabilize and smooth out fluctuations in energy supply and demand for the components. With respect to the dynamic load points, and in some such embodiments, the ultracapacitors may be installed at points in the system where rapid changes in load occur, which in turn, helps to balance the energy supply and prevent voltage drops and/or surges.

Additionally, and in some embodiments, the system may use PCMs in its energy distribution network. Such PCMs may comprise materials that store and release thermal energy by undergoing phase transitions, such as from solid to liquid or vice versa. In some embodiments, the PCMs absorb excess thermal energy during periods of high heat (e.g., when the material melts within the structurally flexible component) and release it when the heat drops (e.g., when the material solidifies). Thus, the PCMs may help to balance thermal loads by smoothing out heat fluctuations and reduce the need for additional heating or cooling. In some such embodiments, the PCMs may be integrated into the system and the energy distribution network to manage thermal energy, which may complement the electrical energy storage provided by the lithium-ion batteries, ultracapacitors, and/or the like. In some such embodiments, the PCMs may be incorporated into thermal management components within the system described herein, such as heat sinks, thermal insulation components, and/or the like.

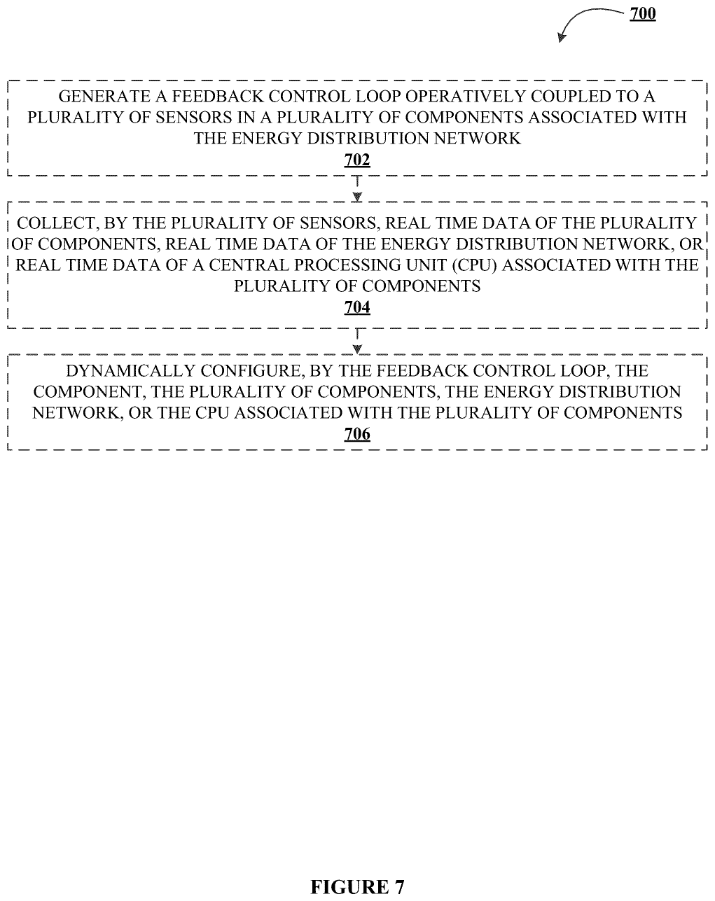

FIG. 7 illustrates a process flow 700 for dynamically configuring the component, the plurality of components, the energy distribution network, and/or the central processing unit associated with the plurality of components, in accordance with an embodiment of the disclosure. In some embodiments, a system (e.g., similar to one or more of the systems described herein with respect to FIGS. 1A-1C) may perform one or more of the steps of process flow 700. For example, a system (e.g., the system 130 described herein with respect to FIG. 1A-1C) may perform the steps of process 700. In some embodiments, a machine learning model (e.g., such as the ML engine shown in FIG. 2) may perform some or all of the steps described in process flow 700.

In some embodiments, and as shown in block 702, the process flow 700 may include the step of generating a feedback control loop operatively coupled to a plurality of sensors in a plurality of components associated with the energy distribution network. For instance, and in some such embodiments, the system may generate a feedback control loop that is operatively coupled (or connected) to a plurality of sensors associated with a plurality of components (e.g., placed near, connected to, and/or the like, to the components) associated with the energy distribution network. Such a feedback control loop may be integrated in the system to act as a feedback loop for the system described herein, which will make sure that the system is operating correctly and associated components are operating as expected (e.g., as expected with respect to the energy consumption simulation and/or the predicted energy consumption). Thus, and in such embodiments, the feedback control loop may oversee the system described herein, its associated components, and ensure continuous operation of the system and its components, and/or the like. Such a feedback control loop may verify the continuous operation based on the real time sensor data of the components and whether the real time sensor data matches or is close to the expected sensor data (e.g., expected energy consumption based on the energy consumption simulation and/or predicted energy consumption).

In some embodiments, and as shown in block 704, the process flow 700 may include the step of collecting, by the plurality of sensors, real time data of the plurality of components, real time data of the energy distribution network, or real time data of a central processing unit (CPU) associated with the plurality of components. For instance, and in some such embodiments, the system may collect—using the plurality of sensors connected to the feedback control loop—the real time data of the plurality of components, real time data of the energy distribution network (e.g., the energy distribution network′ operational data, current connections and configurations, and/or the like), and/or the real time data of a CPU associated with the system and/or the plurality of components.

In some embodiments, and as shown in block 706, the process flow 700 may include the step of dynamically configuring, by the feedback control loop, the component, the plurality of components, the energy distribution network, or the CPU associated with the plurality of components. Thus, and in some such embodiments, the system may dynamically configure—by the feedback control loop and based on the real time data collected—the component, the plurality of components, the energy distribution network, and/or the CPU, in real time and/or near real time to determining a problem with any of the component, the plurality of components, the energy distribution network, and/or the CPU.

Thus, and as used herein, the feedback control loop may automatically adjust the processes described herein based on the real time sensor data, by continuously monitoring and regulating the performance of the component, the plurality of components, the energy distribution network, and/or the CPU. Thus, the feedback control loop may use data from the plurality of sensors to make automatic adjustments (e.g., automatic adjustments to the energy distribution network) to maintain optimal system performance and operation. By way of non-limiting example, if the heat sensors detect that a component is overheating, the feedback control loop may adjust the energy flow to redirect excess heat or activate cooling mechanisms, which may ensure the system operates within safe and efficient parameters.

Additionally, and/or alternatively, to the feedback control loop described herein, the system may comprise a redundancy mechanism. Such a redundancy mechanism may refer to a backup system and/or components designed and configured to take over automatically in the event of a primary system failure. Thus, and in some such embodiments, the redundancy mechanism comprises hardware, software, network components, and/or the like, which may ensure continuous operation and system reliability. In some embodiments, the redundancy mechanism may work by duplicating critical system components and/or the processes within the system described herein and/or within the components associated with the system described herein. Thus, and in such embodiments, if a primary component fails (e.g., a component associated with the system), the system may automatically switch to a backup component to maintain operation without interruption (whereby such an automatic switch may be carried out by the configuration of the energy distribution network and the structurally flexible component's configuration). Thus, and by using the redundancy mechanism described herein, the system minimizes the downtime and enhances system reliability by ensuring that backup systems are available to take over in case of a failure. By way of non-limiting example, and in data centers, redundant power supplies are used to ensure uninterrupted operation, and if the primary power supply fails, the redundant power supply may immediately take over, preventing any disruption in data center operations and ensuring continuous availability of services. Thus, and in some embodiments, the redundancy mechanisms may be built into critical components of the system described herein and/or the critical components associated with the system described herein, such as but not limited to energy storage units and/or control systems, to provide backup support in case of failures.

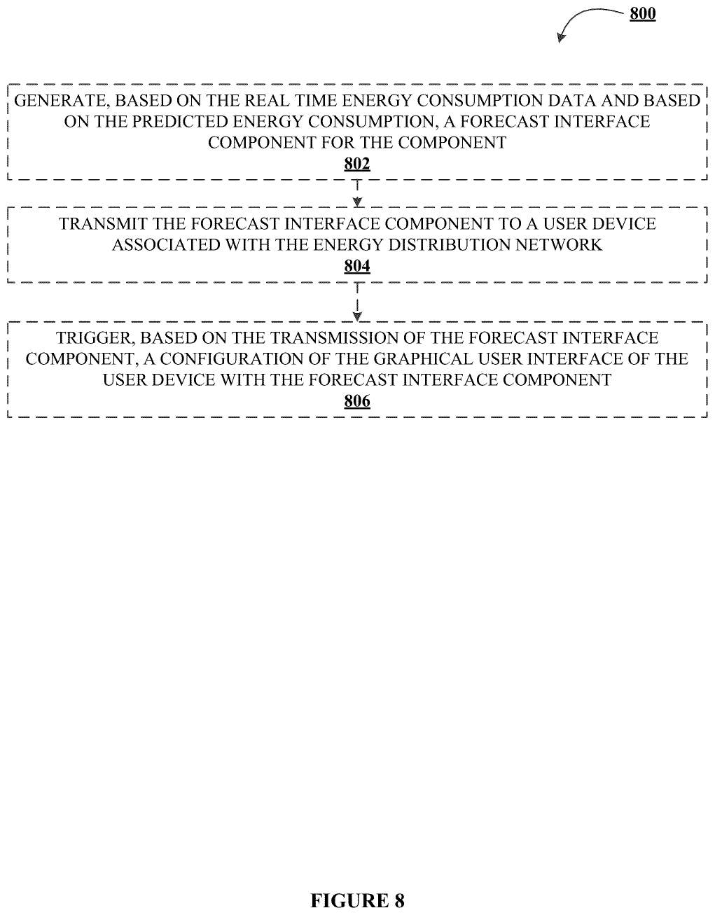

FIG. 8 illustrates a flow diagram 800 for triggering a configuration of a graphical user interface (GUI) of a user device with a forecast interface component, in accordance with an embodiment of the disclosure. In some embodiments, a system (e.g., similar to one or more of the systems described herein with respect to FIGS. 1A-1C) may perform one or more of the steps of flow diagram 800. For example, a system (e.g., the system 130 described herein with respect to FIG. 1A-1C) may perform the steps of flow diagram 800. In some embodiments, a machine learning model (e.g., such as the ML engine shown in FIG. 2) may perform some or all of the steps described in flow diagram 800.

In some embodiments, and as shown in block 802, the process flow 800 may include the step of generating, based on the real time energy consumption data and based on the predicted energy consumption, a forecast interface component for the component. For example, and in some such embodiments, the system may generate a forecast interface component, which may comprise the data regarding the component's real time energy consumption data and the predicted energy consumption data in a computer-readable format. Further, the computer-readable format of the forecast interface component may comprise computer readable program code or instructions to configure a GUI of a user device to showcase the data of at least the real time energy consumption data and/or the predicted energy consumption at a future period or instance. In some embodiments, the forecast interface component may comprise the data of the energy consumption simulation, which may show the user the line graphs of the historical energy consumption of the component(s) and the predicted energy consumption of the component(s) at a future time(s).

In some embodiments, and as shown in block 804, the process flow 800 may include the step of transmitting the forecast interface component to a user device associated with the energy distribution network. For instance, and in some embodiments, the system may transmit the forecast interface component to a user device associated with the energy distribution network, whereby the user device associated with the energy distribution network may be associated with an entity that owns, operates, and/or manages the components in the energy distribution network. Thus, and in some such embodiments, the user device may be interacted with by a user associated with the entity that owns, operates, and/or manages the components, to show the historical energy consumption data, the real time energy consumption data, and the predicted energy consumption for the components, in real time and as a predication for future problems or issues that may need to be addressed.

In some embodiments, and as shown in block 806, the process flow 800 may include the step of triggering, based on the transmission of the forecast interface component, a configuration of a graphical user interface (GUI) of the user device with the forecast interface component. For instance, and in some such embodiments, the system may trigger—by transmitting the forecast interface component—the configuration of the user device's GUI to showcase the data regarding each component's historical energy consumption data, the real time energy consumption data, and the predicted energy consumption in a human-readable format. Further, and in some embodiments, the configuration of the GUI may allow for the user to interact with the information and data showcasing the historical energy consumption data, the real time energy consumption data, and the predicted energy consumption of various components, such that the user may select and isolate the information of each component, individually, and its associated energy consumption data (e.g., historical energy consumption data, the real time energy consumption data, and the predicted energy consumption). Additionally, and in some embodiments, the configuration of the GUI may comprise a pop up notification for each component where a potential issue (e.g., where a predicted energy consumption shows a future energy shortage and/or a future energy overload) is expected, which may alert the user of the user device to fix the problem before the potential issue actually occurs.

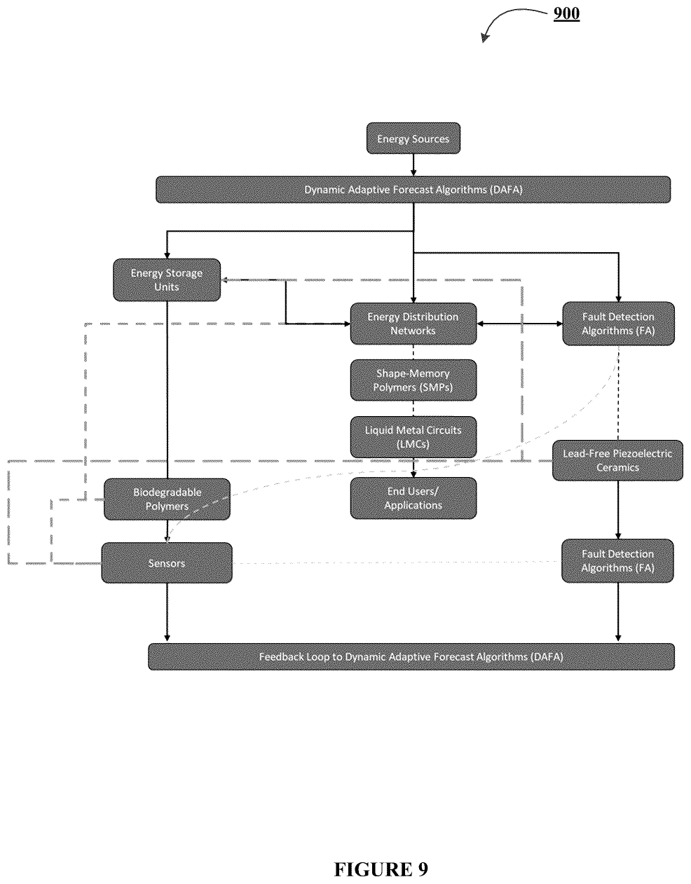

FIG. 9 illustrates a flow diagram 900 for automatically and dynamically redistributing energy between data sources and power sources, in accordance with an embodiment of the disclosure. In some embodiments, a system (e.g., similar to one or more of the systems described herein with respect to FIGS. 1A-1C) may perform one or more of the steps of flow diagram 900. For example, a system (e.g., the system 130 described herein with respect to FIG. 1A-1C) may perform the steps of flow diagram 900. In some embodiments, a machine learning model (e.g., such as the ML engine shown in FIG. 2) may perform some or all of the steps described in flow diagram 900.

As shown herein in flow diagram 900, the energy sources may provide the initial energy input for the system, such as from the sensors proximately located with and/or connected to components associated with the system. Additionally, and as shown herein, the dynamic adaptive forecast algorithm is an exemplary term to describe the dynamic forecast module described herein. Such a dynamic forecast module may take the sensor data for each component and make current readings and predictions regarding the energy consumption of the components, and may further adapt or configure the energy distribution network in response to the output of the dynamic forecast module. Additionally, and as shown in flow diagram 900, energy storage units may store excess energy and release the excess energy as needed, and is shown with various connections to the dynamic forecast module, the lead-free piezoelectric ceramics, the biodegradable polymers, and/or the energy distribution network(s) associated with the SMPs, LMCs, and/or the like.

Further, and as shown in flow diagram 900, the dynamic forecast module may be connected to the fault detection module (fault detection algorithm), which may ensure that the system is acting in accordance with its purpose and operating correctly. Such fault detection module may be connected (via the lead-free piezoelectric ceramics, the fault detection algorithms, and the sensors) to the feedback loop, which in turn is connected to the dynamic forecast module.

In some embodiments, biodegradable polymers may be used in particular components described herein, throughout the system described herein, and/or the like. For example, such biodegradable polymers are engineered to break down naturally in the environment, which minimizes long-term waste and reduces the ecological impact on the environment. Such biodegradable polymers are designed to decompose through biological processes, such as but not limited to microbial action, which may convert the biodegradable polymers into non-toxic byproducts. Thus, and in such embodiments, the biodegradable polymers may decompose into simpler, non-toxic components over time when exposed to environmental factors like moisture, heat, and microorganisms. This breakdown process may help reduce the accumulation of plastic waste and lessen the environmental footprint of the materials. By way of non-limiting example, the biodegradable polymers may comprise polylactic acid (PLA), which is derived from renewable resources like cornstarch or sugarcane, and breaks down into natural components like carbon dioxide and water under composting conditions, which is an improvement over traditional petroleum plastics.

In some embodiments, the system may comprise these biodegradable polymers used in non-critical components and outer casings of the system described herein to ensure environmental friendliness without comprising core functionality. As used herein, the non-critical components comprising the biodegradable polymers refers to those components associated with the system that are not directly involved in energy storage or conversion but may be essential for structural integrity or external protection. In some embodiments, the biodegradable polymers may be used in the enclosures that protect internal components from environmental factors while ensuring that the core functionality of the system is unaffected.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for automatically and dynamically redistributing energy between data sources and power sources, the system comprising:
a memory device with computer-readable program code stored thereon;
at least one processing device operatively coupled to the at least one memory device and the at least one communication device, wherein executing the computer-readable code is configured to cause the at least one processing device to:
identify a component associated with an energy consumption;
receive, from at least one sensor associated with the component, real time energy consumption data of the component;
determine, by a dynamic forecast module connected to the at least one sensor, a predicted energy consumption;
generate an energy distribution network comprising at least one structurally flexible component and the component;
apply at least one external factor to the at least one structurally flexible component based on the predicted energy consumption; and
dynamically configure, based on the at least one external factor applied to the at least one structurally flexible component, at least one connection within the energy distribution network.

2. The system of claim 1, wherein the structurally flexible component comprises at least one of a Shape Memory Polymer (SMP) based component, a Liquid Metal Circuit (LMC) based component, a Shape-Memory Alloy (SMA), or an elastomeric polymer.

3. The system of claim 1, wherein the at least one sensor is embedded in at least one of an energy collection component, an energy distribution network, a liquid metal circuit (LMC) based component, an energy storage component, a feedback control loop component, an interface component, or a transfer component.

4. The system of claim 1, wherein the dynamic forecast module comprises at least one of a predictive model, a fuzzy logic model, or an optimization module.

5. The system of claim 1, wherein executing the computer-readable code is further configured to cause the at least one processing device to:
collect historical data of the component;
generate a first historical dataset of the component;
train the first historical dataset to the dynamic forecast module at a first instance by applying the first historical dataset to the dynamic forecast module;
collect real time data of the component at a current instance;
train the real time data to the dynamic forecast module at a current instance by applying the real time data to the dynamic forecast module; and
generate, by training the dynamic forecast module in the first instance and the current instance, the predicted energy consumption.

6. The system of claim 5, wherein executing the computer-readable code is further configured to cause the at least one processing device to:
generate, by the trained dynamic forecast module and based on the real time data, an energy consumption simulation of the component;
determine, based on the energy consumption simulation, a future energy shortage or a future energy overload; and
dynamically configure, at a future period and based on the determined future energy shortage or the future energy overload, at least one connection within the energy distribution network at the future period.

7. The system of claim 1, wherein executing the computer-readable code is further configured to cause the at least one processing device to:
generate a fault control module, wherein the fault control module is operatively coupled with the component;
compare, by the fault control module, the real time energy consumption data with at least one energy threshold for the component, wherein the at least one energy threshold is based on a collection of historical data of the component; and
automatically shutdown the component in an instance where the real time energy consumption data meets or exceeds the at least one energy threshold for the component.

8. The system of claim 7, wherein executing the computer-readable code is further configured to cause the at least one processing device to:
dynamically configure, based on the automatic shutdown of the component, the at least one connection within the energy distribution network by applying the at least one external factor to the at least one structurally flexible component;
automatically connect, within the energy distribution network and based on the dynamic configuration, the at least one structurally flexible component to at least one secondary component.

9. The system of claim 1, wherein executing the computer-readable code is further configured to cause the at least one processing device to:
generate a feedback control loop operatively coupled to a plurality of sensors in a plurality of components associated with the energy distribution network;
collect, by the plurality of sensors, real time data of the plurality of components, real time data of the energy distribution network, or real time data of a central processing unit (CPU) associated with the plurality of components; and
dynamically configure, by the feedback control loop, the component, the plurality of components, the energy distribution network, or the CPU associated with the plurality of components.

10. The system of claim 1, wherein executing the computer-readable code is further configured to cause the at least one processing device to:
generate, based on the real time energy consumption data and based on the predicted energy consumption, a forecast interface component for the component;
transmit the forecast interface component to a user device associated with the energy distribution network; and
trigger, based on the transmission of the forecast interface component, a configuration of a graphical user interface (GUI) of the user device with the forecast interface component.

11. A computer program product for automatically and dynamically redistributing energy between data sources and power sources, the computer program product comprising a non-transitory computer-readable medium comprising code causing an apparatus to:
identify a component associated with an energy consumption;
receive, from at least one sensor associated with the component, real time energy consumption data of the component;
determine, by a dynamic forecast module connected to the at least one sensor, a predicted energy consumption;
generate an energy distribution network comprising at least one structurally flexible component and the component;
apply at least one external factor to the at least one structurally flexible component based on the predicted energy consumption; and
dynamically configure, based on the at least one external factor applied to the at least one structurally flexible component, at least one connection within the energy distribution network.

12. The computer program product of claim 11, wherein the structurally flexible component comprises at least one of a Shape Memory Polymer (SMP) based component, a Liquid Metal Circuit (LMC) based component, a Shape-Memory Alloy (SMA), or an elastomeric polymer.

13. The computer program product of claim 11, wherein the at least one sensor is embedded in at least one of an energy collection component, an energy distribution network, a liquid metal circuit (LMC) based component, an energy storage component, a feedback control loop component, an interface component, or a transfer component.

14. The computer program product of claim 11, wherein the computer program product further comprises non-transitory computer-readable medium comprising code causing the apparatus to:
collect historical data of the component;
generate a first historical dataset of the component;
train the first historical dataset to the dynamic forecast module at a first instance by applying the first historical dataset to the dynamic forecast module;
collect real time data of the component at a current instance;
train the real time data to the dynamic forecast module at a current instance by applying the real time data to the dynamic forecast module; and
generate, by training the dynamic forecast module in the first instance and the current instance, the predicted energy consumption.

15. The computer program product of claim 14, wherein the computer program product further comprises non-transitory computer-readable medium comprising code causing the apparatus to:
generate, by the trained dynamic forecast module and based on the real time data, an energy consumption simulation of the component;
determine, based on the energy consumption simulation, a future energy shortage or a future energy overload; and
dynamically configure, at a future period and based on the determined future energy shortage or the future energy overload, at least one connection within the energy distribution network at the future period.

16. A computer implemented method for automatically and dynamically redistributing energy between data sources and power sources, the computer implemented method comprising:
identifying a component associated with an energy consumption;
receiving, from at least one sensor associated with the component, real time energy consumption data of the component;
determining, by a dynamic forecast module connected to the at least one sensor, a predicted energy consumption;
generating an energy distribution network comprising at least one structurally flexible component and the component;
applying at least one external factor to the at least one structurally flexible component based on the predicted energy consumption; and
dynamically configuring, based on the at least one external factor applied to the at least one structurally flexible component, at least one connection within the energy distribution network.

17. The computer implemented method of claim 16, wherein the structurally flexible component comprises at least one of a Shape Memory Polymer (SMP) based component, a Liquid Metal Circuit (LMC) based component, a Shape-Memory Alloy (SMA), or an elastomeric polymer.

18. The computer implemented method of claim 16, wherein the at least one sensor is embedded in at least one of an energy collection component, an energy distribution network, a liquid metal circuit (LMC) based component, an energy storage component, a feedback control loop component, an interface component, or a transfer component.

19. The computer implemented method of claim 16, further comprising:
collecting historical data of the component;
generating a first historical dataset of the component;
training the first historical dataset to the dynamic forecast module at a first instance by applying the first historical dataset to the dynamic forecast module;
collecting real time data of the component at a current instance;
training the real time data to the dynamic forecast module at a current instance by applying the real time data to the dynamic forecast module; and
generating, by training the dynamic forecast module in the first instance and the current instance, the predicted energy consumption.

20. The computer implemented method of claim 16,
generating, by the trained dynamic forecast module and based on the real time data, an energy consumption simulation of the component;
determining, based on the energy consumption simulation, a future energy shortage or a future energy overload; and
dynamically configuring, at a future period and based on the determined future energy shortage or the future energy overload, at least one connection within the energy distribution network at the future period.
